(19) United States
(12) Patent Application Publication
(10) Pub. No.: US 2013/0147865 A1
(43) Pub. Date: Jun. 13, 2013

(54) SINGLE-PROJECTION WIDESCREEN PROJECTING DEVICE AND SINGLE-PROJECTION WIDESCREEN PROJECTING METHOD

(71) Applicants: Qixiong Chen, Fuzhou (CN); Shunda Shao, Fuzhou (CN); Rong Zhang, Fuzhou (CN)

(72) Inventors: Qixiong Chen, Fuzhou (CN); Shunda Shao, Fuzhou (CN); Rong Zhang, Fuzhou (CN)

(73) Assignee: FUJIAN NETCOM TECHNOLOGY CO., LTD., Fuzhou (CN)

(21) Appl. No.: 13/255,790

(22) PCT Filed: Jan. 20, 2011
(86) PCT No.: PCT/CN11/70423

§ 371 Date: Sep. 9, 2011

(30) Foreign Application Priority Data
Aug. 31, 2010 (CN) 201010268058.6
Aug. 31, 2010 (CN) 201010268767.4
Aug. 31, 2010 (CN) 201010269164.6

(51) Int. Cl. G09G 5/10

(52) U.S. Cl. CPC G09G 5/10
USPC 345/697

(57) ABSTRACT

A single-projection widescreen projecting device includes an image processing system and in turns in the direction of light path an optical non-imaging system providing a light source; an optical imaging system; a light path switching system; and a projecting lens which projects a magnified image onto a screen. The image processing system connects the optical imaging system to the light path switching system and is used to divide the image into N frames of small images and then transmit the small images to the optical imaging system. N is natural numeral greater than 1. At the moment of transmitting the small images to the optical imaging system, a corner signal corresponding to each frame of the small images is transmitted the light path switching system. The optical imaging system is used to receive N frames of the small images and light rays from the optical non-imaging system and then display the N frames of the small images after the light rays of the optical non-imaging system are adjusted. The light path switching system includes a mirror and a rotary motor. The rotary motor is used to receive the corner signal to control the rotating angle of the mirror. This invention uses a single-projection technology to achieve the widescreen projection with superior frame display ratio to the current art.

### BACKGROUND OF THE INVENTION

1. Field of the Invention

The present invention relates to a single-projection widescreen projecting device and single-projection widescreen projecting method.

2. Description of Related Art

In the recent years, various areas in industry attach great importance to the field of information technology. The need of information visualization of large-scale, high-clarity and high-resolution display has been rapidly expanding.

There are two existing widescreen projecting technology: one adapts a multi-projection widescreen projection and the other uses single-projection widescreen projection.

The first widescreen projecting technology—multi-projection widescreen projection—uses a number of projecting units each of which includes an illuminating optical system, an image display panel and a projecting optical system. After the images projected from each projecting unit has been stitched, there are obvious seams between the screens. Even though the current technology has tried to make the seams relatively small, it affects somehow the overall effect of the stitched picture frame.

Even though the second widescreen projecting technology—single projection- has no more than one projector and therefore no seams like the multiple-projection technology, the image display is limited to the screen aspect ratio of 4:3 or 16:9 or 16:10. Such a smaller proportion of the image display cannot meet the need of big-screen wide-vision field display for modern life.

However, both types of widescreen projecting technologies have the deficiencies of high production cost, large volume and inconvenience to carry.

Therefore, there is a need of a novel single-projection widescreen projecting device and single-projection widescreen projecting method which overcome the above disadvantages.

### SUMMARY OF THE INVENTION

The object of the present invention is to provide a single-projection widescreen projecting device and a single-projection widescreen projecting method, which realizes a real widescreen projection.

In order to achieve the above and other objectives, a single-projection widescreen projecting device of the invention includes an image processing system and in turns in the direction of light path an optical non-imaging system providing a light source; an optical imaging system; a light path switching system; and a projecting lens which projects a magnified image onto a screen. The image processing system connects the optical imaging system to the light path switching system and is used to divide the image into N frames of small images and then transmit the small images to the optical imaging system. N is natural numeral greater than 1. At the moment of transmitting the small images to the optical imaging system, a corner signal corresponding to each frame of the small images is transmitted the light path switching system. The optical imaging system is used to receive N frames of the small images and light rays from the optical non-imaging system and then display the N frames of the small images after the light rays of the optical non-imaging system are adjusted. The light path switching system includes a mirror having a rotary motor. By means of using the corner signal to control the rotary motor to drive the mirror to rotate, each frame of the small images is projected onto the screen.

The optical non-imaging system includes in turns a light source, a shaper and an aligning device.

The optical imaging system includes in turns in the direction of light path a polarizer, a prism, an image display device and an analyzer.

An aligning system having at least one aligning lens is located between the optical imaging system and the light path switching system.

The image processing system further includes the following components which are connected in turns: a conversion IC, used to convert image signals of the different interfaces into RGB pixel digital signals, synchronization signals and control signals; and a control IC, used to convert the RGB pixel digital signals output from the conversion IC into N frames of small images. N is a natural number greater than 1. Each frame of the small images are scanned, and then transmitted to the image display device of the optical imaging system. At the moment of scanning, corresponding corner signals are output.

The corner signal corresponding to each frame of the small images further includes a corner signal corresponding to the first frame of the small images used to control the rotary motor to drive the mirror to rotate so that the angle between the mirror and the optical shaft satisfies the angle of projection for the first frame of the small images; a corner signal corner signal corresponding to the second frame of the small images used to control the rotary motor to drive the mirror to rotate so that the angle between the mirror and the optical shaft satisfies the angle of projection for the second frame of the small images. As such, each frame of the small images can be projected onto the screen in the similar way.

The scanning of each frame of the small images is achieved by controlling RGB, HS, VS, DE, and DCLK.

In another aspect of the invention, a single-projection widescreen projecting device includes an image processing system and in turn in the direction of light path an optical non-imaging system providing a light source; an optical imaging system; a light path switching system; and a projecting lens which projects a magnified image onto a screen. The image processing system connects the optical imaging system to the light path switching system and is used to divide the image into N frames of small images and then transmit the small images to the optical imaging system. N is natural numeral greater than 1. At the moment of transmitting the small images to the optical imaging system, a light switching signal corresponding to each frame of the small images is transmitted the light path switching system. The optical imaging system is used to receive N frames of the small images and light rays from the optical non-imaging system and then display the N frames of the small images after the light rays of the optical non-imaging system are adjusted. The light path switching system includes N mirrors, and N or N-1 light switches. One of the light switches connects to a mirror. The light switch is used to receive light signals from the image processing system to control the working status of the mirrors which have correspondingly pre-set angle relative to an optical shaft.

The optical non-imaging system includes in turns a light source, a shaper and an aligning device.

The optical imaging system includes in turns in the direction of light path a polarizer, a prism, an image display device and an analyzer.

An aligning system having at least one aligning lens is located between the optical imaging system and the light path switching system.

The image processing system further includes the following components which are connected in turns: a conversion IC, used to convert image signals of the different interfaces into RGB pixel digital signals, synchronization signals and control signals; and a control IC, used to convert the RGB pixel digital signals output from the conversion IC into N frames of small images. N is a natural number greater than 1. Each frame of the small images are scanned, and then transmitted to the image display device of the optical imaging system. At the moment of scanning, corresponding light switching signals are output.

When the light switch is #N light switch, the light switching signal controls the #N light switch. The light switching signal corresponding to the first frame of the small images allows the first mirror to be working, i.e., in the light path of projection of the small images. The light switching signal corresponding to the second frame of the small images closes the first mirror while the second mirror comes to work, i.e., the first mirror deprives from the light path of projection of the small images but the second mirror is in the light path of projection of the small images. Similarly, the light switching signal of the #m frame of the small images closes the #m-1 mirror while the #m mirror comes to work. m is a natural numeral smaller than to equal to N. The small images are completely projected onto the screen through the #m mirror.

When the light switch is the #N-1 light switch, the light switching signal controls the #N-1 light switch. The light switching signal corresponding to the first frame of the small images allows the first mirror to be working, i.e., in the light path of projection of the small images. The light switching signal corresponding to the second frame of the small images closes the first mirror while the second mirror comes to work, i.e., the first mirror deprives from the light path of projection of the small images but the second mirror is in the light path of projection of the small images. Similarly, the light switching signal of the #m frame of the small images closes the #m-1 mirror while the #m mirror comes to work. m is a natural numeral smaller than to equal to N. The small images are completely projected onto the screen through the #m mirror. The #N mirror keeps working, i.e., in the light path of projection of the small images.

The control IC is used to control RGB, HS, VS, DE and DCLK to achieve the scanning of each frame of the small images.

The amount of the mirrors of the light path switching system is larger than the amount of the divided small images.

The light switch is either a mechanic light switch which changes the light path according to the movement of optical devices, or non-mechanic light switch which changes the light path by changing the optical refractive index according to electro-optic effect, magneto-optical effect, acousto-optic effect or thermo-optic effect.

A single-projection widescreen projecting method of the invention includes the following steps:

001. converting image signals of different interfaces into RGB digital pixel signals, synchronized signals and control signals;

002. Dividing the converted RGB digital pixel signals into N frames of small images, wherein N is a natural numeral and greater than 1;

003. Scanning each small image, wherein a control signal corresponding to each frame of the small images is output for control of the light path switching;

004. Respectively transmitting the scanned N frames of the small images to the image display device;

005. Providing light rays by a light source, wherein the light rays emits to the image display device after subject to pre-processing; and

006. Projecting each frame of the small images on the screen at a corresponding position by controlling the corresponding light path switch after subject to processing.

At Step 003, the scanning of each frame of the small images is achieved by controlling RGB, HS, VS, DE and DCLK.

At Step 006, light path switching is performed by using the control signals to control a set of mirrors having pre-set angles relative to the optical shaft. The set of the mirrors has the same amount as the small images.

The control signals are the light switching signals. The light switching signal corresponding to the first frame of the small images allows the first mirror to be working, i.e., in the light path of projection of the small images. The light switching signal corresponding to the second frame of the small images closes the first mirror while the second mirror comes to work, i.e., the first mirror deprives from the light path of projection of the small images but the second mirror is in the light path of projection of the small images. Similarly, the light switching signal of the #m frame of the small images closes the #m-1 mirror while the #m mirror comes to work. m is a natural numeral smaller than to equal to N. The small images are completely projected onto the screen through the #m mirror.

The #N mirror has been working, i.e., been in the light path of projection of the small images, and does not receive any light switching signals.

The light path switching at Step 006 is performed by using the control signal to control a rotating angle of a mirror. The control signal is a rotating signal. The rotating signal corresponding to each frame of the small images respectively controls the rotating angle of the corresponding mirror so that the angle between a front side of the mirror and the optical shaft becomes a determined angle.

The pre-processing at Step 005 further includes polarizing the light rays after shaped and aligned, and then projecting the polarized light rays onto the image display device.

The processing at Step 006 further includes analyzing each frame of the small images and aligning the analyzed small images.

Compared to the conventional technologies which cost high, have large size and are inconvenient to carry, the invention offers advantages as follows.

1. With single-projection technology, the image is divided and then transmitted to an image display device. The control of the mirrors in the light path switching by the light switching signals can achieve the widescreen projection, with superior frame display ratio to the current art. Shortages in the current art such as small frame display ratio and inferior visual effect can be overcome.

2. The production cost can be significantly reduced with compact volume. Therefore a micro-projector capable of offering widescreen projection can be realized. Problems of high production cost and large volume which are not in favor of promotion of the widescreen projector can be overcome.

The control IC used in the invention includes a set of RGB signal transmission module. That means a set of signals are sufficient for achieving the widescreen projection. Therefore, the whole control IC has simplified circuit design with wide range of IC models. It solves the current problems such as the need of multiple sets of RGB signal transmission modules, complexity in circuit design of the control IC, and limitation in choosing IC models to high-performance high-integrity control ICs, all the problems being disfavor of reducing the production cost and promotion of the widescreen projectors.

In order to further the understanding regarding the present invention, the following embodiments are provided along with illustrations to facilitate the disclosure of the present invention.

### BRIEF DESCRIPTION OF THE DRAWINGS

FIG. 1 is a schematic view of a single-projection widescreen projecting device according to a first embodiment of the invention.

FIG. 2 is a schematic view of a corner signal a single-projection widescreen projecting device according to a first embodiment of the invention.

FIG. 3 is a schematic view of a single-projection widescreen projecting device according to a second embodiment of the invention.

FIG. 4 is a schematic view of a light switching signal of a single-projection widescreen projecting device according to a second embodiment of the invention.

FIG. 5 is a schematic view of a single-projection widescreen projecting device according to a third embodiment of the invention.

FIG. 6 is a schematic view of a single-projection widescreen projecting method according to the invention.

FIG. 7 is a schematic view of light path switching of a single-projection widescreen projecting method according to a first embodiment of the invention.

FIG. 8 is a schematic view of light path switching of a single-projection widescreen projecting method according to a second embodiment of the invention.

FIG. 9 is a schematic view of an undivided image in a light path switch of a single-projection widescreen projecting method according to the invention.

FIG. 10 is a schematic view of 3 small images obtained by dividing an image of FIG. 9.

FIG. 11 is a schematic view of projection of the small images onto a screen of FIG. 10.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

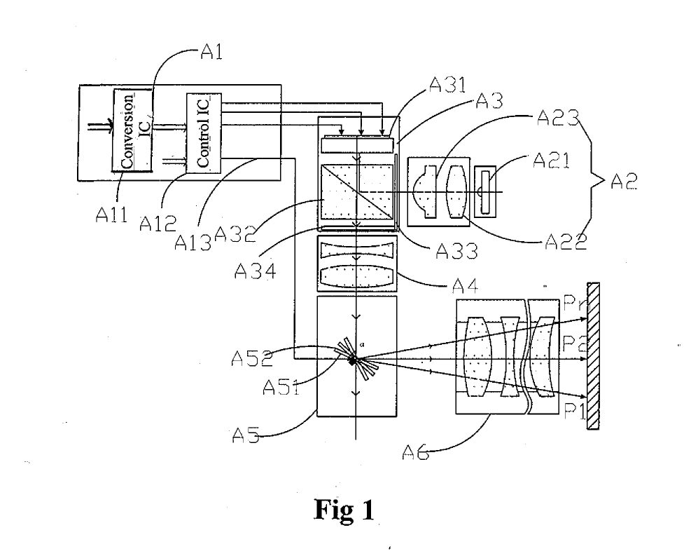

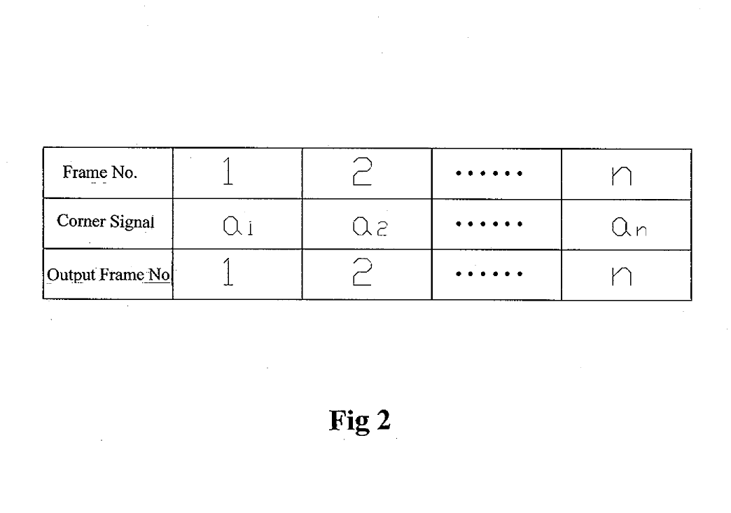

Referring to FIG. 1 and FIG. 2, a single-projection widescreen projecting device according to a first embodiment of the present invention includes an image processing system A1 and in turns in the direction of light path an optical non-imaging system A2 providing a light source, an optical imaging system A3, a light path switching system A5, a projecting lens A6 which projects a magnified image onto a screen. An aligning system A4 is located between the optical imaging system A3 and the light path switching system A5.

The image processing system A1 connects respectively to the optical image processing systems A3 and the light path switching system A5. The image processing system Al specifically includes a conversion IC A11 and a control IC A12. After an image signal enters the conversion IC A11 converts image signals of different interfaces into RGB digital pixel signals, synchronized signals and control signals. Then the user controls input and thus the control IC A12 is subject to sub-frame processing of image data. The image date is thus divided into N frames of small images. N is a natural numeral and greater than 1. Then each small image is scanned by controlling the RGB, HS, VS, DE and DCLK. At the same time of scanning, the output corresponding to the corner signals A13 responding to each small image is transmitted to the light path switching system. After the scan is complete, the control IC A12 passes the N frames of the small images to the optical imaging system A3.

The non-imaging optical system A2 includes a light source A21, an accurate shaping device A22 and an alignment device A23. The light source A21 can be a conventional light bulb, LED lighting or laser lighting. The accurate shaping device A22 and the alignment device A23 respectively shapes and aligns the light rays from the light source A21.

The optical imaging system A3 is used to receive the N frames of the small images and the light rays from the non-imaging optical system A2. Specifically the optical imaging system A3 includes an image display device A31, a prism A32, a polarizer A33 and an analyzer A34. The image display device A31 can be, for example, LCOS (Liquid Crystal On Silicon) panels or DLP (Digital Light Processing) panels or LCD panels, etc. when the light rays from the optical non-imaging system A2 come into the optical imaging system A3, the rays travels through the polarizer A33 to get polarized light, and then reflects by the prism A32 onto the image display device A31. After the N frames of the scanned small images are transferred to the image display device A31, they are output through an analyzer A34.

The alignment system A4 consists of two aligning lenses. The light rays which come into the optical imaging system A3 become in parallel when output from the aligning lenses. The energy focuses in a predetermine direction. The light rays are transmitted to the light path switching system A5.

The light path switching system A5 includes a mirror A51 on which a rotating motor A52 is installed. Referring to FIG. 2, the light path switching system further includes a corner signal ∂₁ corresponding to the first frame of the small images, by which the rotating motor A52 is controlled to drive the mirror A51 to rotate so that an angle between the mirror A51 and the optical shaft satisfies a projected angle of the first frame of the small images to project the first frame of the small images onto the screen at a first p₁ position. The light path switching system further includes a corner signal ∂₂ corresponding to the second frame of the small images, by which the rotating motor A52 is controlled to drive the mirror A51 to rotate so that an angle between the mirror A51 and the optical shaft satisfies a projected angle of the second frame of the small images to project the second frame of the small images onto the screen at a second p₂ position. Similarly, each frame of the small images is projected onto screen at the corresponding position.

The projecting lens A6 is used to magnify the images and then project the magnified images onto the screen. The reflected images at the off-axis position require a plurality of lenses for correction, coma, astigmatism and distortion.

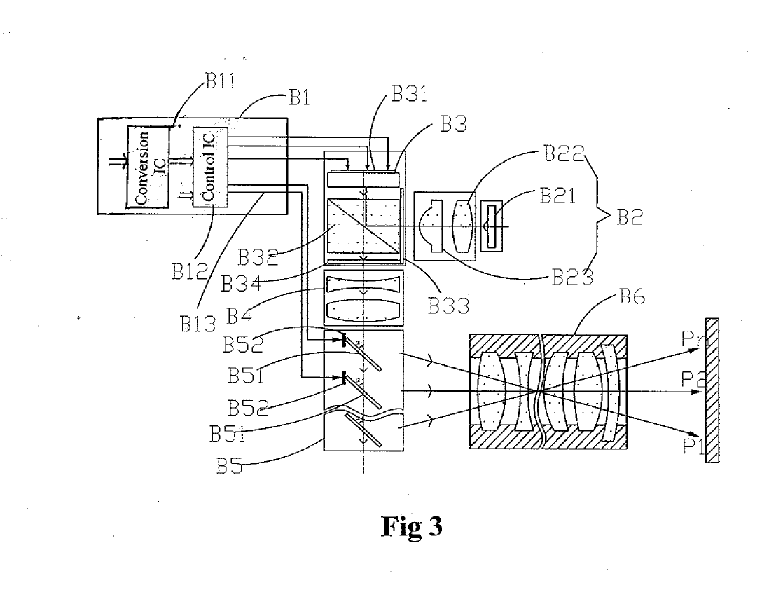

FIG. 3 through FIG. 5 schematically illustrate a single-projection widescreen projecting device according to a second embodiment of the present invention.

Referring to FIG. 3, the single-projection widescreen projecting device according to a second embodiment of the present invention includes an image processing system B1 and in turns in the direction of light path an optical non-imaging system B2 providing a light source, an optical imaging system B3, a light path switching system B5, a projecting lens B6 which projects a magnified image onto a screen. An aligning system B4 is located between the optical imaging system B3 and the light path switching system B5.

The image processing system B1 connects respectively to the optical image processing systems B3 and the light path switching system B5. The image processing system B1 specifically includes a conversion IC B11 and a control IC B12. After an image signal enters the conversion IC B11 converts image signals of different interfaces into RGB digital pixel signals, synchronized signals and control signals. Then the user controls input and thus the control IC B12 is subject to sub-frame processing of image data. The image date is thus divided into N frames of small images. N is a natural numeral and greater than 1. Then each small image is scanned by controlling the RGB, HS, VS, DE and DCLK. At the same time of scanning, the output corresponding to the corner signals B13 responding to each small image is transmitted to the light path switching system. After the scan is complete, the control IC B12 passes the N frames of the small images to the optical imaging system B3.

The non-imaging optical system B2 includes a light source B21, an accurate shaping device B22 and an alignment device B23. The light source B21 can be a conventional light bulb, LED lighting or laser lighting. The accurate shaping device B22 and the alignment device B23 respectively shapes and aligns the light rays from the light source B21.

The optical imaging system B3 is used to receive the N frames of the small images and the light rays from the non-imaging optical system B2. Specifically the optical imaging system B3 includes an image display device B31, a prism B32, a polarizer B33 and an analyzer B34. The image display device B31 can be, for example, DMD (Digital Micromirror Device) panels, LCOS (Liquid Crystal On Silicon) panels, DLP (Digital Light Processing) panels or LCD panels, etc. When the light rays from the optical non-imaging system B2 come into the optical imaging system B3, the rays travels through the polarizer B33 to get polarized light, and then reflects by the prism B32 onto the image display device B31. After the N frames of the scanned small images are transferred to the image display device B31, they are output through an analyzer B34.

The alignment system B4 consists of two aligning lenses. The light rays which come into the optical imaging system B3 become in parallel when output from the aligning lenses. The energy focuses in a predetermine direction. The light rays are transmitted to the light path switching system B5.

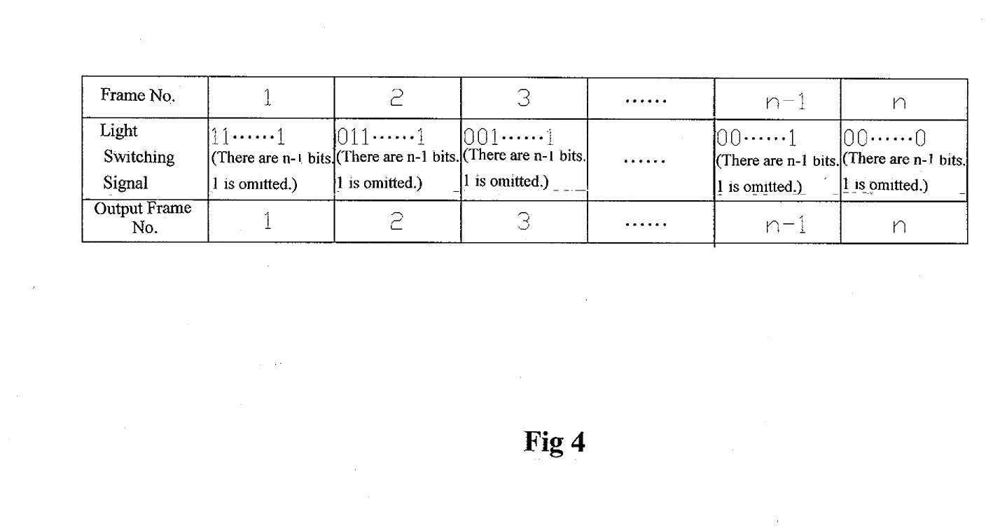

The light path switching system B5 includes a set of mirrors B51 on at least one of which a light switch B52 is installed. In this embodiment, the number of the mirrors B51 is the same as the number (N) of frames of the small images. N is a natural numeral and greater than 1. The light switch B52 can be either a mechanic light switch which changes the light path according to the movement of optical devices, or non-mechanic light switch which changes the light path by changing the optical refractive index according to electro-optic effect, magneto-optical effect, acousto-optic effect or thermo-optic effect. The mirror #N has been working, that has been in the light path of projection of the small images, not connecting to the light switch. By controlling the working status of the light switch B52, the light switching signal B13 can be used to control the working status of the mirrors B51. Referring to FIG. 4, it is assumed that when the light switching signal is 1, the light switch allows the mirrors to be in the light path of projection of the small images; and when the light switching signal is 0, the light switch deprives the mirrors from the light path of projection of the small images. The light switching signal 11 . . . 1 of the first frame allows the first mirror to be working, i.e., in the light path of projection of the small images so that the light rays reach the screen at position p₁ after pass through the first mirror. The light switching signal 011 . . . 1 of the second frame closes the first mirror while the second mirror comes to work, i.e., the first mirror deprives from the light path of projection of the small images so that the second mirror is in the light path of projection of the small images and the light rays reach the screen at position p₂ after pass through the second mirror. Similarly, the light switching signal of the #m (1≦m≦n-1) frame of the small images closes the #m-1 mirror while the #m mirror comes to work, i.e. the #m-1 mirror deprives from the light path of projection of the small images and the #m mirror is in the light path of projection of the small images. m is a natural numeral. The #m mirror completely reflects the small images. The next mirror will not affect the projection of the small images. The light rays reach the screen at position pₙ after reach the #N mirror. By setting the angle of each mirror and the optical shaft, the N frames of the small images are in turns projected on the screen at the corresponding position.

The projecting lens B6 is used to magnify the images and then project the magnified images onto the screen. The reflected images at the off-axis position require a plurality of lenses for correction, coma, astigmatism and distortion.

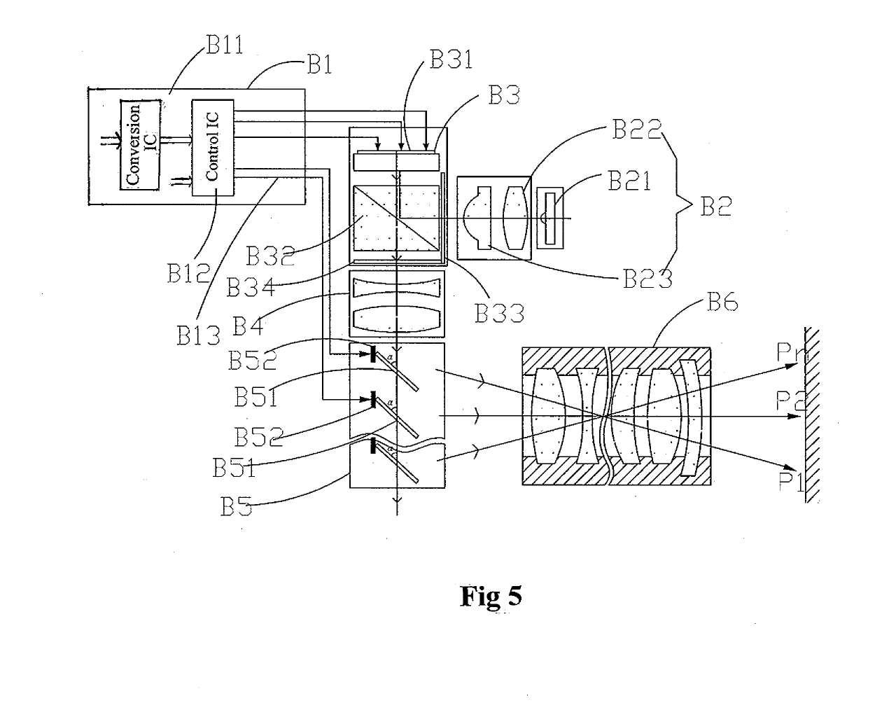

FIG. 5 is a schematic view of a single-projection widescreen projecting device according to a third embodiment of the invention. This embodiment is the same as the second embodiment, except that in the light path switching system B5, each mirror B51 has a light switch B52 corresponding to the light switching signal B13 of each frame of the small images for controlling the work status of the light switch. By setting the angle of each mirror B51 and the optical shaft, the N frames of the small images are in turns projected on the screen at the corresponding position.

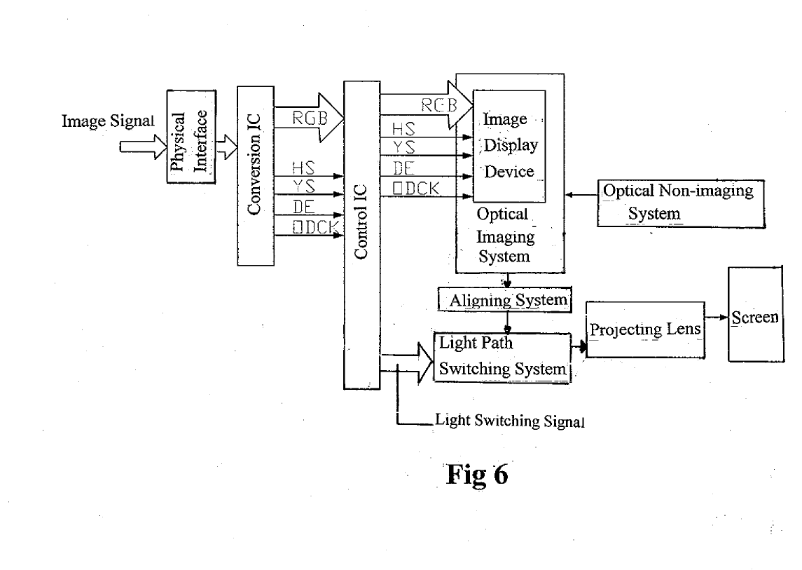

FIG. 6 through FIG. 11 illustrate a single-projection widescreen projecting method of the invention.

Referring to FIG. 6, the image signals come from a physical interface to be converted, i.e., the image signals of different interfaces will be converted into 24-bit RGB pixel digital signals, synchronization signals and control signals. Then the digital images are divided into small image frames N, N is natural number greater than 1. By controlling the RGB, HS (horizontal sync signal), VS (vertical sync signal), DE (data enable signal) and DCLK (data clock frequency), scanning each frame of the small images. At the same moment of scanning each frame of the small images, control signals which are used to control the switching of the light path. A light source provides light rays which reach the image display panels after being shaped, aligned and polarized. After the scanned small images are transmitted to the image display panel, they are reflected on the screen at the corresponding to the switching of the light path controlled by the control signals. The following Examples further illustrate this invention in details.

### EXAMPLE 1

### Of Single-Projection Widescreen Projecting Method

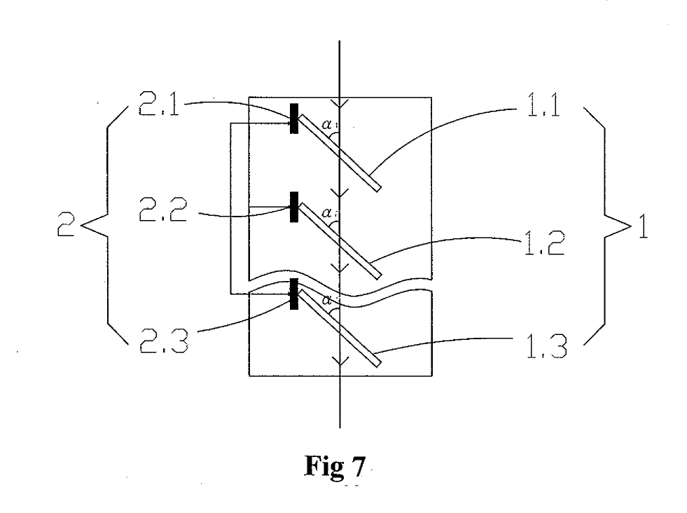

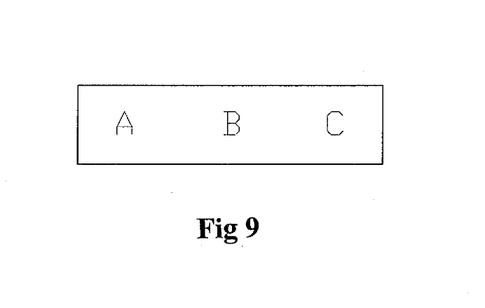

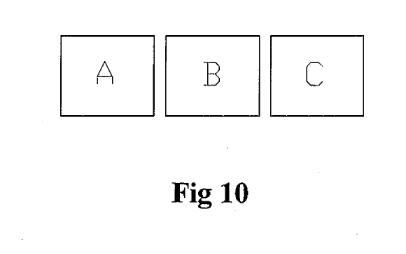

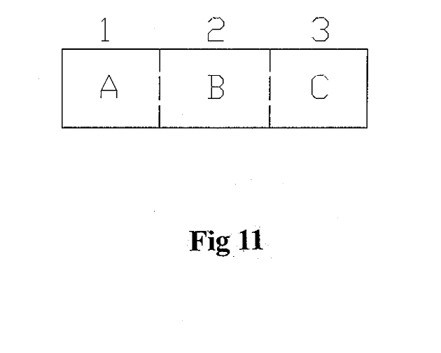

Referring to FIG. 6, FIG. 7, FIG. 9, FIG. 10, and FIG. 11, the light path switching system includes a set of mirrors 1 on each of which a light switch 2 is installed. The light switch 2 can be either a mechanic light switch which changes the light path according to the movement of optical devices, or a non-mechanic light switch which changes the light path by changing the optical refractive index according to electro-optic effect, magneto-optical effect, acousto-optic effect or thermo-optic effect. The amount of the mirrors 1 is larger than to equal to the amount of the small images. The control signal is a light switching signal. By controlling the working status of the light switch 2, the light switching signal can be used to control the working status of the mirrors 1. The light switching signal of the first frame allows the first mirror to be working, i.e., in the light path of projection of the small images. The light switching signal of the second frame closes the first mirror while the second mirror comes to work, i.e., the first mirror deprives from the light path of projection of the small images but the second mirror is in the light path of projection of the small images. Similarly, the light switching signal of the #m frame of the small images closes the #m-1 mirror while the #m mirror comes to work, i.e. the #m-1 mirror deprives from the light path of projection of the small images but the #m mirror is in the light path of projection of the small images. m is a natural numeral smaller than to equal to N. The mirror next to the #m mirror will not affect the projection of the small images. The small images are completely projected onto the screen through the #m mirror. It is assumed that the #N mirror has been working. By setting the angle of each mirror and the optical shaft, the N frames of the small images are in turns projected on the screen at the corresponding position. In a case that the image is divided into 3 frames of small images, the light path switching system includes a first mirror 1.1 having a light switch 2.1, a second mirror 1.2 having a light switch 2.2 and a third mirror 1.3 having a light switch 2.3.

It is assumed that when the light switch K=1, the mirror is in the light path of projection of the small images, and when the light switch K=0, the mirror deprives from the light path of projection of the small images.

It is assumed that the first mirror 1.1 is K₁, the second mirror 1.2 is K₂ and the third mirror 1.3 is K₃.

At Step 1, a digital image signal of an image is divided into three small images, as shown in FIG. 10.

At Step 2, by using the light switch to control the working status of the light switch 2 to make K₁=1, K₂=1, K₃=1. Furthermore, the scanning of the image A in FIG. 10 is achieved by controlling the RGB, HS, VS, DE and DCLK. After the scanning is complete, the image A in FIG. 10 is transmitted to the image display panel. According to the working status of the corresponding mirror, the image A is projected onto the screen at position 1 as shown in FIG. 11 through the first mirror 1.1.

At Step 3, by using the light switch to control the working status of the light switch to make K₁=0, K₂=1, K₃=1. Furthermore, the scanning of the image B in FIG. 10 is achieved by controlling the RGB, HS, VS, DE and DCLK. After the scanning is complete, the image B in FIG. 10 is projected onto the screen at position 2 as shown in FIG. 11 through the first mirror 1.2. The transmission of the light path of the image is the same as at Step 2.

At Step 4, by using the light switch to control the working status of the light switch to make K₁=0, K₂=0, K₃=1. Furthermore, the scanning of the image C in FIG. 10 is achieved by controlling the RGB, HS, VS, DE and DCLK. After the scanning is complete, the image C in FIG. 10 is projected onto the screen at position 3 as shown in FIG. 11 through the first mirror 1.3. The transmission of the light path of the image is the same as at Step 2.

### EXAMPLE 2

### Of Single-Projection Widescreen Projecting Method

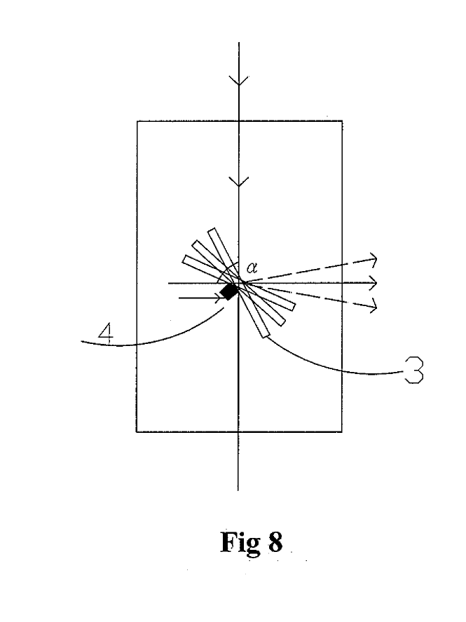

Referring to FIG. 6, FIG. 8, FIG. 9, FIG. 10 and FIG. 11, the light path switching system includes a mirror 3 having a rotary motor 4. The control signal is a corner signal which can be used to control the rotation of the mirror 3 by means of the rotation of the rotary motor 4. When the first frame of the small images is transmitted, the corner signal controls the rotary motor 4 to drive the mirror 3 to rotate to a corresponding angle, so that the first frame of the small images is projected onto the screen at a corresponding position. When the second frame of the small images is transmitted, the corner signal controls the rotary motor 4 to drive the mirror 3 to rotate to a corresponding angle, so that the second frame of the small images is projected onto the screen at a corresponding position. Similarly, by means of controlling the rotary motor 4 to drive the mirror 3 to rotate so as to form a corresponding angle between the mirror 3 and the shaft, each frame of the small images can be in turns projected onto the screen at their corresponding positions. In a case that the image is divided into 3 frames of small images, the light path switching system includes a mirror having a rotary motor.

It is assumed that ∂₁, ∂₂, ∂₃ are the angles between the mirror and the optical shaft respectively for the first frame, the second and the third of the small images.

At Step 1, a digital image signal of an image is divided into three small images, as shown in FIG. 10.

At Step 2, by using the corner signal to control the rotary motor to drive the mirror to rotate, and control the angle ∂₁ between the mirror and the optical shaft. Furthermore, the scanning of the image A in FIG. 10 is achieved by controlling the RGB, HS, VS, DE and DCLK. After the scanning is complete, the image A is projected onto the screen at position 1 as shown in FIG. 11.

At Step 3, by using the corner signal to control the rotary motor to drive the mirror to rotate, and control the angle ∂₁ between the mirror and the optical shaft. Furthermore, the scanning of the image B in FIG. 10 is achieved by controlling the RGB, HS, VS, DE and DCLK. After the scanning is complete, the image B in FIG. 10 is projected onto the screen at position 2 as shown in FIG. 11. The transmission of the light path of the image is the same as at Step 2.

At Step 4, by using the corner signal to control the rotary motor to drive the mirror to rotate, and control the angle ∂₃ between the mirror and the optical shaft. Furthermore, the scanning of the image C in FIG. 10 is achieved by controlling the RGB, HS, VS, DE and DCLK. After the scanning is complete, the image C in FIG. 10 is projected onto the screen at position 3 as shown in FIG. 11. The transmission of the light path of the image is the same as at Step 2.

By implementing Step 1 through Step 4, only one image display device is needed to realize 3-screen display. The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A single-projection widescreen projecting device, characterized in comprising an image processing system and in turns in the direction of light path an optical non-imaging system providing a light source;
an optical imaging system; a light path switching system; and a projecting lens which projects a magnified image onto a screen;
wherein
the image processing system connects the optical imaging system to the light path switching system and is used to divide the image into N frames of small images and then transmit the small images to the optical imaging system; N is natural numeral greater than 1; at the moment of transmitting the small images to the optical imaging system, a corner signal corresponding to each frame of the small images is transmitted the light path switching system;
the optical imaging system is used to receive N frames of the small images and light rays from the optical non-imaging system and then display the N frames of the small images after the light rays of the optical non-imaging system are adjusted;
the light path switching system includes a mirror having a rotary motor; by means of using the corner signal to control the rotary motor to drive the mirror to rotate, each frame of the small images is projected onto the screen.

2. The single-projection widescreen projecting device of claim 1, characterized in that the optical non-imaging system comprises in turns a light source, a shaper and an aligning device.

3. The single-projection widescreen projecting device of claim 1, characterized in that the optical imaging system includes in turns in the direction of light path a polarizer, a prism, an image display device and an analyzer.

4. The single-projection widescreen projecting device of claim 1, characterized in that an aligning system having at least one aligning lens is located between the optical imaging system and the light path switching system.

5. The single-projection widescreen projecting device of claim 1, characterized in that the image processing system further includes the following components which are connected in turns: a conversion IC, used to convert image signals of the different interfaces into RGB pixel digital signals, synchronization signals and control signals; and a control IC, used to convert the RGB pixel digital signals output from the conversion IC into N frames of small images. N is a natural number greater than 1; wherein each frame of the small images are scanned, and then transmitted to the image display device of the optical imaging system; and at the moment of scanning, corresponding corner signals are output.

6. The single-projection widescreen projecting device of claim 1 or 5, characterized in that the corner signal corresponding to each frame of the small images further comprises a corner signal corresponding to the first frame of the small images used to control the rotary motor to drive the mirror to rotate so that the angle between the mirror and the optical shaft satisfies the angle of projection for the first frame of the small images; a corner signal corner signal corresponding to the second frame of the small images used to control the rotary motor to drive the mirror to rotate so that the angle between the mirror and the optical shaft satisfies the angle of projection for the second frame of the small images; and each frame of the small images can be projected onto the screen in the similar way.

7. The single-projection widescreen projecting device of claim 1, characterized in that the scanning of each frame of the small images is achieved by using the control IC to control RGB, HS, VS, DE, and DCLK.

8. A single-projection widescreen projecting device, characterized in comprising an image processing system and in turns in the direction of light path an optical non-imaging system providing a light source;
an optical imaging system; a light path switching system; and a projecting lens which projects a magnified image onto a screen;
wherein
the image processing system connects the optical imaging system to the light path switching system and is used to divide the image into N frames of small images and then transmit the small images to the optical imaging system; N is natural numeral greater than 1; at the moment of transmitting the small images to the optical imaging system, a light switching signal corresponding to each frame of the small images is transmitted the light path switching system;
the optical imaging system is used to receive N frames of the small images and light rays from the optical non-imaging system and then display the N frames of the small images after the light rays of the optical non-imaging system are adjusted;
the light path switching system includes N mirrors, and N or N-1 light switches; one of the light switches connects to a mirror; the light switch is used to receive light signals from the image processing system to control the working status of the mirrors which have correspondingly pre-set angle relative to an optical shaft.

9. The single-projection widescreen projecting device of claim 8, characterized in that optical non-imaging system includes in turns a light source, a shaper and an aligning device.

10. The single-projection widescreen projecting device of claim 8, characterized in that the optical imaging system includes in turns in the direction of light path a polarizer, a prism, an image display device and an analyzer.

11. The single-projection widescreen projecting device of claim 8, characterized in that an aligning system having at least one aligning lens is located between the optical imaging system and the light path switching system.

12. The single-projection widescreen projecting device of claim 8, characterized in that the image processing system further includes the following components which are connected in turns: a conversion IC, used to convert image signals of the different interfaces into RGB pixel digital signals, synchronization signals and control signals; and a control IC, used to convert the RGB pixel digital signals output from the conversion IC into N frames of small images. N is a natural number greater than 1; each frame of the small images are scanned, and then transmitted to the image display device of the optical imaging system; and at the moment of scanning, corresponding light switching signals are output.

13. The single-projection widescreen projecting device of claim 8 or 12, characterized in that when the light switch is #N light switch, the light switching signal controls the #N light switch;
the light switching signal corresponding to the first frame of the small images allows the first mirror to be working, i.e., in the light path of projection of the small images;
the light switching signal corresponding to the second frame of the small images closes the first mirror while the second mirror comes to work, i.e., the first mirror deprives from the light path of projection of the small images but the second mirror is in the light path of projection of the small images;
similarly, the light switching signal of the #m frame of the small images closes the #m-1 mirror while the #m mirror comes to work. m is a natural numeral smaller than to equal to N; and
the small images are completely projected onto the screen through the #m mirror.

14. The single-projection widescreen projecting device of claim 8 or 12, characterized in that when the light switch is the #N-1 light switch, the light switching signal controls the #N-1 light switch;
the light switching signal corresponding to the first frame of the small images allows the first mirror to be working, i.e., in the light path of projection of the small images;
the light switching signal corresponding to the second frame of the small images closes the first mirror while the second mirror comes to work, i.e., the first mirror deprives from the light path of projection of the small images but the second mirror is in the light path of projection of the small images;
similarly, the light switching signal of the #m frame of the small images closes the #m-1 mirror while the #m mirror comes to work; m is a natural numeral smaller than to equal to N; the small images are completely projected onto the screen through the #m mirror; and
the #N mirror keeps working, i.e., in the light path of projection of the small images

15. The single-projection widescreen projecting device of claim 8, characterized in that the control IC is used to control RGB, HS, VS, DE and DCLK to achieve the scanning of each frame of the small images.

16. The single-projection widescreen projecting device of claim 8, characterized in that the amount of the mirrors of the light path switching system is larger than the amount of the divided small images.

17. The single-projection widescreen projecting device of claim 8, characterized in that the light switch is either a mechanic light switch which changes the light path according to the movement of optical devices, or non-mechanic light switch which changes the light path by changing the optical refractive index according to electro-optic effect, magneto-optical effect, acousto-optic effect or thermo-optic effect.

18. A single-projection widescreen projecting method, comprising the following steps:
001. converting image signals of different interfaces into RGB digital pixel signals, synchronized signals and control signals;
002. dividing the converted RGB digital pixel signals into N frames of small images, wherein N is a natural numeral and greater than 1;
003. scanning each small image, wherein a control signal corresponding to each frame of the small images is output for control of the light path switching;
004. respectively transmitting the scanned N frames of the small images to the image display device;
005. providing light rays by a light source, wherein the light rays emits to the image display device after subject to pre-processing; and
006. projecting each frame of the small images on the screen at a corresponding position by controlling the corresponding light path switch after subject to processing.

19. The single-projection widescreen projecting method of claim 18, characterized in that at the Step 003, the scanning of each frame of the small images is achieved by controlling RGB, HS, VS, DE and DCLK.

20. The single-projection widescreen projecting method of claim 18, characterized in that at Step 006, light path switching is performed by using the control signals to control a set of mirrors having pre-set angles relative to the optical shaft; and the set of the mirrors has the same amount as the small images.

21. The single-projection widescreen projecting method of claim 20, characterized in that the control signals are the light switching signals; the light switching signal corresponding to the first frame of the small images allows the first mirror to be working, i.e., in the light path of projection of the small images; the light switching signal corresponding to the second frame of the small images closes the first mirror while the second mirror comes to work, i.e., the first mirror deprives from the light path of projection of the small images but the second mirror is in the light path of projection of the small images; similarly, the light switching signal of the #m frame of the small images closes the #m-1 mirror while the #m mirror comes to work; m is a natural numeral smaller than to equal to N; and the small images are completely projected onto the screen through the #m mirror.

22. The single-projection widescreen projecting method of claim 21, characterized in that the #N mirror has been working, i.e., been in the light path of projection of the small images, and does not receive any light switching signals.

23. The single-projection widescreen projecting method of claim 18, characterized in that the light path switching at Step 006 is performed by using the control signal to control a rotating angle of a mirror; the control signal is a rotating signal; and the rotating signal corresponding to each frame of the small images respectively control the rotating angle of the corresponding mirror so that the angle between a front side of the mirror and the optical shaft becomes a determined angle.

24. The single-projection widescreen projecting method of claim 18, characterized in that the pre-processing at Step 005 further includes polarizing the light rays after shaped and aligned, and then projecting the polarized light rays onto the image display device.

25. The single-projection widescreen projecting method of claim 18, characterized in that the processing at Step 006 further includes analyzing each frame of the small images and aligning the analyzed small images.
